(19) United States
(12) Patent Application Publication
(10) Pub. No.: US 2006/0101572 A1
(43) Pub. Date: May 18, 2006

(54) Mixing apparatus for warm bath apparatus

(76) Inventor: Masatoshi Masuda, Kyoto-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/154,191

(22) Filed: Jun. 16, 2005

(30) Foreign Application Priority Data
Nov. 18, 2004 (JP) 2004-334359

(51) Int. Cl. A61H 33/06

(52) U.S. Cl. 4/541.5

(57) ABSTRACT

A warm bath apparatus includes a warm bathtub for feet 22, a pair of warm bathtubs for arms 21, and a liquid-treating apparatus 1 which treats a liquid flowing into/out from the warm bathtubs 20. The liquid-treating apparatus 1 includes a heater 50, a circulation mechanism 70 having flow paths 71-75, a gas-supply mechanism 90 for supplying a gas in circulating liquid, a filtration mechanism 100 for purifying the circulating liquid, and a mixing mechanism 110 for dissolving the gas by mixing it in the liquid.

### BACKGROUND OF THE INVENTION

1. Field of the Invention

The present invention generally relates to a warm bath apparatus comprising a mixing mechanism for dissolving a gas by mixing it in a liquid.

2. Description of the Related Art

As this type of warm bath apparatuses, an apparatus described in Japanese Patent Laid-open No.2001-204787, which supplies carbon dioxide gas by mixing it in bathtub water in order to bring out effects such as promoting blood circulation in the body, has been known. The apparatus described in Japanese Patent Laid-open No.2001-204787 comprises a circulation flow path, the water intake and the spout of which are connected to inside a bathtub, a pump for circulating the bathtub water in the circulation flow path, a diaphragm electrolysis electrode cell for generating acidic water to be supplied to the bathtub water being circulated in the circulation flow path, and a carbonic acid dissolver for filling up carbonate to be supplied to the bathtub water circulating in the circulation flow path. Consequently, according to the apparatus described in Japanese Patent Laid-open No.2001-204787, it becomes possible to supply carbon dioxide gas generated by the interaction of acidic water and carbonate into the bathtub by mixing it in the bathtub water circulating in the circulation flow path.

The apparatus described in Japanese Patent Laid-open No.2001-204787, however, cannot dissolve carbon dioxide gas in the bathtub water moderately because it is configured to mix the bathtub water and carbon dioxide gas together simply by letting a cathode water supply-path, a carbon dioxide gas supply-path and a main path interflow. Consequently, according to the apparatus described in Japanese Patent Laid-open No.2001-204787, a problem that even if carbon dioxide gas is supplied into the bathtub by mixing it with the bathtub water, the carbon dioxide gas mixed in flows out immediately, is caused.

### SUMMARY OF THE INVENTION

Consequently, in an aspect, an object of the present invention is to solve one or more of the above-mentioned problems. An object of an embodiment of the present invention is to provide a warm bath apparatus being able to dissolve a gas into a liquid moderately.

The present invention can be practiced in various ways including, but not limited to, embodiments described below, wherein numerals used in the drawings are used solely for the purpose of ease in understanding of the embodiments which should not be limited to the numerals. Further, in the present specification, different terms or names may be assigned to the same element, and in that case, one of the different terms or names may functionally or structurally overlap or include the other or be used interchangeably with the other.

In an aspect, the present invention provides a warm bath apparatus comprising: (I) at least one bathtub (e.g., 21, 22); (II) a liquid-heating device (e.g., 50); (III) a circulation system (e.g., 70) for circulating a liquid between the at least one bathtub and the heating device; and (IV) a mixing unit (e.g., 110, 120) for dissolving a gas by mixing the gas in the liquid being circulated by the circulation mechanism, said mixing mechanism comprising: (i) a gas-supply mechanism (e.g., 90), (ii) a chamber (e.g., 111+112, 121+122) provided downstream of the gas-supply mechanism and having a top portion (e.g., 112, 122) provided with an inflow opening (e.g., 112a, 122a) for introducing the liquid and an outflow opening (e.g., 112b, 122b) for discharging the liquid, and (iii) a tubular hollow body (e.g., 113, 124) provided inside the chamber and having an lower end (e.g., 113a, 124a) disposed adjacent to a bottom of the chamber and an upper end (e.g., 113b, 124b) connected to the outflow opening, wherein the liquid is to pass through the inflow opening, the lower end of the tubular body, the upper end of the tubular body, and the outflow opening in sequence after the gas is mixed therein.

The above embodiment further includes, but is not limited to, the following embodiments:

The chamber may comprise a lid member (e.g., 112, 122) which constitutes the top portion and a container (e.g., 111, 121) connected to the lid member.

The circulation system may have a liquid-inflow pipe (e.g., 73, 74) connected to the inflow opening of the top portion of the chamber, and a liquid-outflow pipe (e.g., 75) connected to the outflow opening of the top portion of the chamber. The gas-supply mechanism may be connected to the liquid-inflow pipe for mixing the gas in the liquid passing through the liquid-inflow pipe. The gas-supply mechanism may be connected to the liquid-inflow pipe via a check valve.

The liquid-heating device may be provided downstream of the mixing unit. The circulation system may further comprise a filtration unit (e.g., 100) for purifying the liquid provided upstream of the mixing unit. The mixing unit may further comprise a filtration portion (e.g., 123) provided inside the chamber between the inflow opening and the lower end of the tubular body. The circulation system may further comprise a discharge pipe (e.g., 83) for discharging the liquid out of the circulation system upstream of the gas-supply mechanism.

The gas-supply mechanism may supply carbon dioxide. The liquid may be water.

The at least one warm bathtub may comprise a warm bathtub for feet (e.g., 22) and a pair of warm bathtubs for arms (e.g., 21). The circulation system may circulate the liquid between the warm bathtub for feet and the pair of warm bathtubs for arms. The warm bath apparatus may further comprise a chair (e.g., 10) having a seat portion (e.g., 1) and a backrest portion (e.g., 12) wherein the warm bathtub for feet is disposed on a lower side of the seat portion in the chair, and the warm bathtubs for arms are disposed on each side of the seat portion in the chair.

The liquid-heating device, the circulation system, and the mixing unit may constitute a liquid-treating apparatus (e.g., 1, 2) as a single module.

In all of the aforesaid embodiments, any element used in an embodiment can interchangeably be used in another embodiment unless such a replacement is not feasible or causes adverse effect. Further, the present invention can equally be applied to apparatuses and methods.

In another aspect, the present invention provides a method of using the warm bath apparatus of any of the foregoing, comprising: (a) filling the at least one bathtub with the liquid; (b) circulating the liquid using the circulation system; (c) heating the liquid using the liquid-heating device; (d) supplying the gas using the gas-supply mechanism; (e) mixing the gas in the liquid using the mixing unit; and (f) controlling the liquid circulation and the gas supply wherein a gas-trapped portion (e.g., 131, 141) is formed at an upper portion of the chamber which is a gas phase including the liquid, under which a gas-dissolved liquid portion (e.g., 132, 142) is formed which is a liquid phase wherein the gas is dissolved.

The above embodiment further includes, but is not limited to, the following embodiments:

In the gas-supplying step, carbon dioxide may be supplied as the gas. In the circulation step, water may be circulated as the liquid.

In the present invention, the term “connected” includes directly or indirectly, physically or functionally connected, depending on the context.

In at least one embodiment, a gas can effectively be dissolved in a liquid despite having a simple configuration. In at least one embodiment, the liquid can be maintained cleanly for a long period of time. In at least one embodiment, reverse flow of the liquid can be prevented. By using at least one embodiment of the warm bath apparatus, blood circulation in the body can further be promoted. In at least one embodiment, costs for using the warm bath apparatus can be lowered. By using at least one embodiment of the warm bath apparatus, blood circulation in the body can be promoted locally by using. In at least one embodiment, a liquid can be supplied to the warm bathtub for feet and to a pair of warm bathtubs for arms at the same time.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to, illustrate and not to limit the invention. The drawings are oversimplified for illustrative purposes.

FIG. 1 is an oblique perspective view showing Embodiment 1 of the present invention.

FIG. 2 is an explanatory view of Embodiment 1 of the present invention by showing its service state from the side.

FIG. 3 is a schematic view showing circulation of a liquid in the warm bath apparatus according to Embodiment 1 of the present invention.

FIG. 4 is an explanatory view showing the filtration mechanism 100 comprising the warm bath apparatus according to Embodiment 1 of the present invention.

FIG. 5 is an explanatory view showing the mixing mechanism 110 comprising the warm bath apparatus according to Embodiment 1 of the present invention.

FIG. 6 is a schematic view showing circulation of a liquid in the warm bath apparatus according to Embodiment 2 of the present invention.

FIG. 7 is an explanatory view showing the filtration/mixing mechanism 120 comprising the warm bath apparatus according to Embodiment 2 of the present invention.

Explanation of symbols used in the drawings are as follows: 1: Liquid-treating apparatus; 2: Liquid-treating apparatus; 10: Chair; 11: Seat portion; 12: Backrest portion; 20: Warm bathtubs; 21: Warm bathtubs for arms; 22: Warm bathtub for feet; 31: Liquid-supply pipe; 32: Liquid-supply pipe; 33: Liquid-supply pipe; 41: Liquid-discharge pipe; 42: Liquid-discharge pipe; 43: Liquid-discharge pipe; 51: Make-and-break valve; 52: Directional control valve; 60: Pump; 70: Circulation mechanism; 72: Flow path; 73: Flow path; 74: Flow path; 75: Flow path; 81: Liquid-discharge pipe; 82: Liquid-discharge pipe; 83: Liquid-discharge pipe; 90: Gas-supply mechanism; 91: Control valve; 92: Check valve; 100: Filtration mechanism; 101: Container, 102: Lid member; 103: Filter; 110: Mixing mechanism; 111: Container; 112: Lid member; 113: Tubular body; 120: Filtration/mixing mechanism; 121: Container; 122: Lid member; 123: Filter; 124: Tubular body.

### DETAILED DESCRIPTION OF THE PREFERRED EMBODIMENT

The present invention will be explained with respect to preferred embodiments. However, the present invention is not limited to the preferred embodiments

Embodiment 1 of the present invention is described in detail below based on drawings attached.

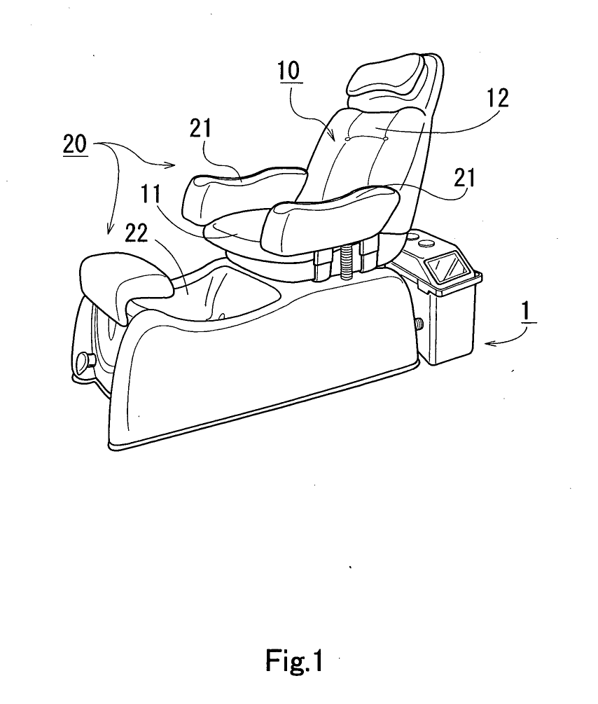

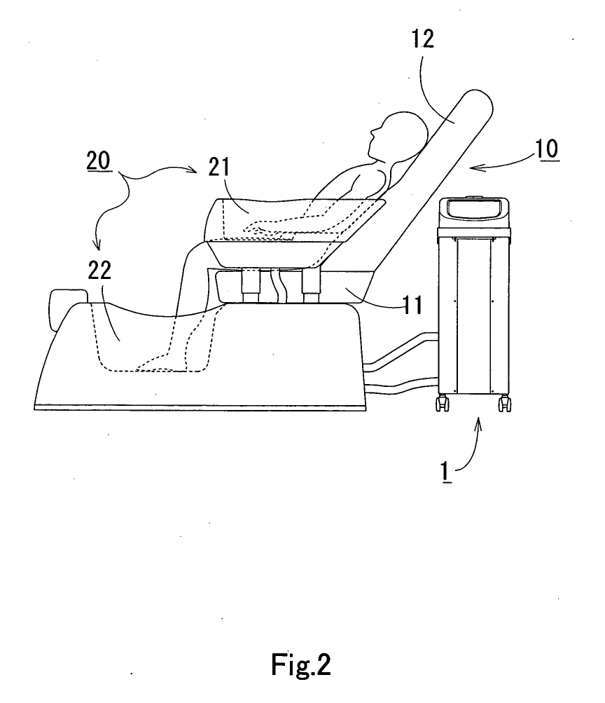

FIG. 1 is an oblique perspective view showing Embodiment 1 of the present invention; FIG. 2 is an explanatory view of Embodiment 1 of the present invention by showing its service state from the side.

The warm bath apparatus according to Embodiment 1 of the present invention comprises a chair 10 having a seat portion 11 and a backrest portion 12, a warm bathtub for feet 22 being disposed on the lower side of the seat portion 11 in the chair 10, warm bathtubs for arms 21 being disposed on each side of the seat portion 11 in the chair 10 (hereinafter, “the warm bathtub for feet 22” and “the warm bathtub for arms 21” are together referred to as “the warm bathtubs 20”.), and a liquid-treating apparatus 1 for treating a liquid flowing out to the warm bathtubs 20.

Because the warm bath apparatus according to Embodiment 1 of the present invention comprises the warm bathtub for feet 22 and a pair of warm bathtubs for arms 21 as described above, it becomes possible to promote blood circulation in the body locally.

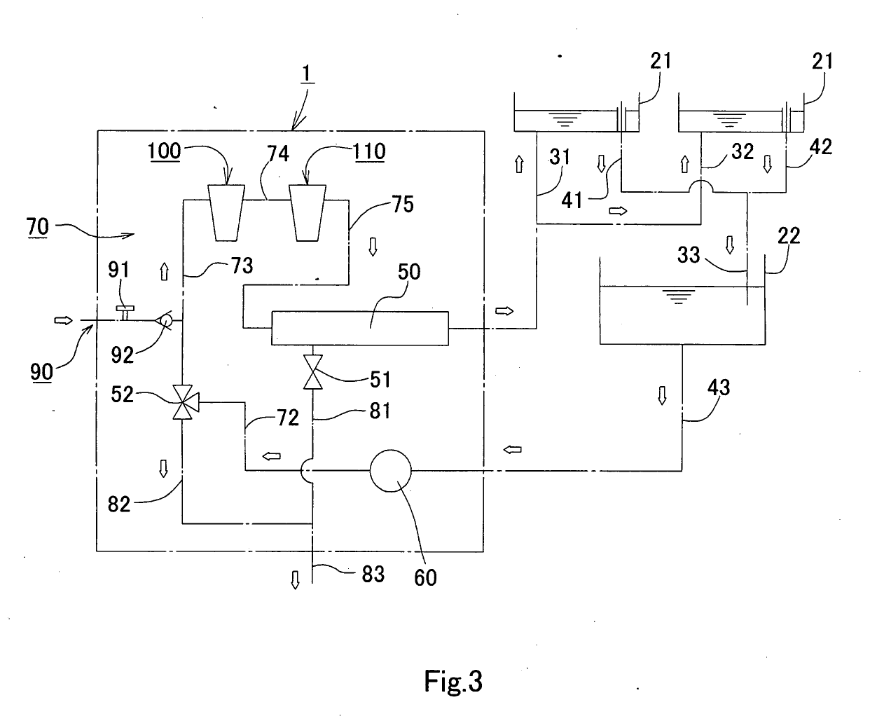

FIG. 3 is a scheme showing liquid circulation in the warm bath apparatus according to Embodiment 1 of the present invention.

A liquid treated in the liquid-treating apparatus 1 is supplied to the warm bathtubs for arms 21 via liquid-supply pipes 31, 32. With the liquid being supplied to the warm bathtubs for arms 21, liquid overflowing from the warm bathtub for arms 21 is discharged through liquid-discharge pipes 41, 42. The liquid discharged from the liquid-discharge pipes 41, 42 is supplied to the warm bathtub for feet 22 via a liquid-supply pipe 33. Liquid stored in the warm bathtub for feet 22 is discharged to the liquid-treating apparatus 1 by a pump 60 provided in the liquid-treating apparatus 1 via the liquid-discharge pipe 43, and is treated in the liquid-treating apparatus 1.

The liquid-treating apparatus 1 comprises a heater 50 as a liquid-heating mechanism, a circulation mechanism 70 having flow paths 71-75 for circulating liquid between the warm bathtubs 20 and the heater 50, a gas-supply mechanism 90 for supplying gas in the liquid being circulated by the circulation mechanism 70, a filtration mechanism 100 for purifying the liquid being circulated by the circulation mechanism 70, and a mixing mechanism 110 for dissolving the gas supplied by the gas-supply mechanism 90 by mixing it in the liquid.

Because the warm bath apparatus according to Embodiment 1 of the present invention comprises the liquid-treating apparatus 1 described above, the warm bathtub for feet 22 and a pair of warm bathtubs for arms 21 are configured to be connected to the same circulation mechanism 70. Consequently, it becomes possible to share the liquid supplied to the warm bathtub for feet 22 and the liquid supplied to a pair of warm bathtubs for arms 21.

The circulation mechanism 70 comprises the flow path 72 connected to a pump 60 for sucking liquid from the warm bathtub for feet 22, the flow path 73 connecting the flow path 72 and the filtration mechanism 100, the flow path 74 connecting the filtration mechanism 100 and the mixing mechanism 110, and the flow path 75 connecting the mixing mechanism 110 and the heater 50.

Between the flow path 72 and the flow path 73, a directional control valve 52, which connects the flow path 72 to either of a liquid discharge pipe 82 connected to a liquid-discharge pipe 83 or the flow path 73, is provided. By this, it becomes possible to discharge the liquid from the warm bathtub for feet 22 directly to the liquid-discharge pipe 83.

Additionally, the heater 50 is connected to the liquid-discharge pipe 83 via a make-and-break valve 51 and the liquid-discharge pipe 82. By this, it becomes possible to easily adjust a liquid amount supplied from the heater to the warm bathtubs for arms 21.

The gas-supply mechanism 90 comprises a control valve 91 for controlling a flow rate of gas from a gas-supply portion, and a check valve 92 for preventing reverse flow of the gas, and is connected to the flow path 73 in the circulation mechanism 70. By this, it becomes possible to adjust a gas amount supplied.

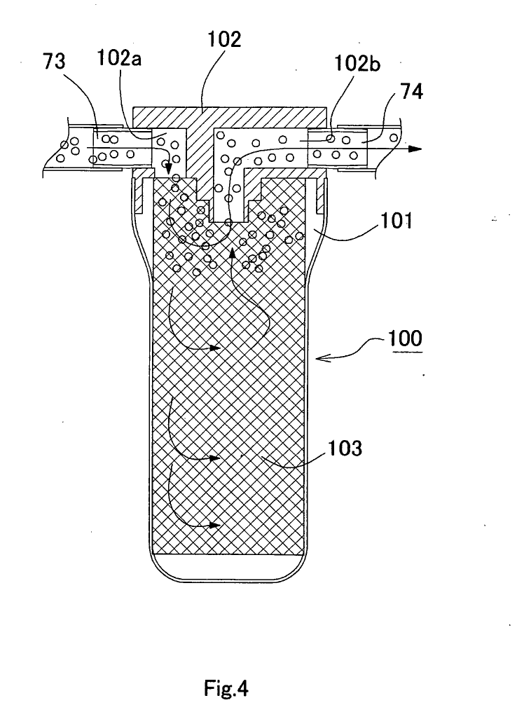

FIG. 4 is an explanatory view showing the filtration mechanism 100 comprising the warm bath apparatus according to Embodiment 1 of the present invention.

The filtration mechanism 100 comprises a tubular container 101 having an opening portion on its top, a lid member 102 for stopping the opening portion of the container 101, and a filter 103 disposed inside the container 101. In the lid member 102, an inflow-hole portion 102a being connected to the flow path 74 and passing through inside the container 101, and an outflow-hole portion 102b being connected to the flow path 73 and passing through inside the container 101 are formed. By this, it becomes possible to discharge the liquid supplied from the flow path 73 to the flow path 74 after filtrating it by the filter 103.

The filter may be made of polypropylene, soft polyethylene, hard polyethylene, etc having continuous pores and having resistance to acid and alkali, various types of salts and organic solvents. The filter can be shaped according to the shape of the container. For example, it has a diameter of approximately 70 mm and a length of approximately 250 mm. In an embodiment, the filter can be press-fitted into the container and replaced with a new filter every 20 or 30 days, for example.

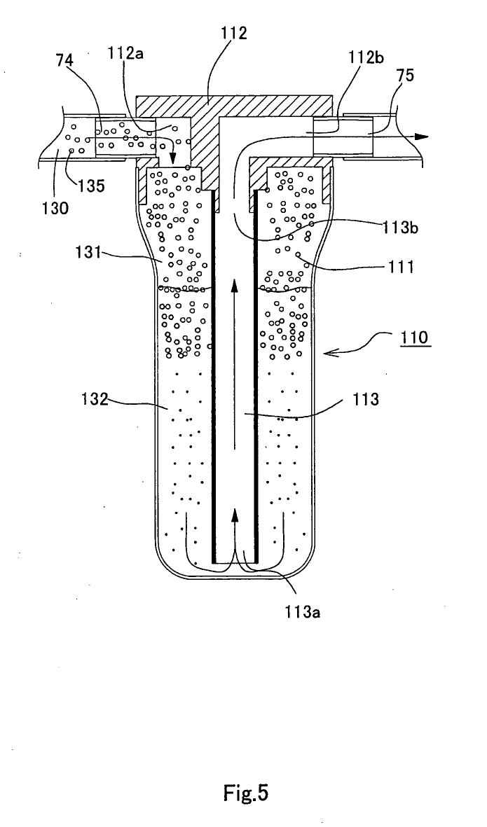

FIG. 5 is an explanatory view showing the mixing mechanism 110 comprising the warm bath apparatus according to Embodiment 1 of the present invention.

The mixing mechanism 110 comprises a tubular container 111 having an opening portion on its top, a lid member 112 for stopping the opening portion of the container 111, and a tubular body 113 disposed inside the container 111. In the lid member 112, an inflow-hole portion 112a being connected to the flow path 74 and passing through inside the container 111, and an outflow-hole portion 112b being connected to the flow path 75 and passing through inside the container 11 are formed. As to the tubular body 113, its lower-end portion opening 113a is disposed adjacent to the bottom portion of the container 111; its upper-end portion opening 113b is connected to the flow path 75 via the outflow-hole portion 112b of the lid member 112.

Consequently, liquid supplied from the flow path 74 is discharged to the flow path 75: after reaching the bottom portion of the container 111. By this, because of difference in specific gravity of a liquid and a gas, convention occurs inside the container 111 by gas flow trying to rise and liquid flow supplied from the flow path 74, thereby making it possible to dissolve the gas in the liquid moderately.

When the liquid is introduced into the mixing mechanism 110 through the flow path 74 and the inflow-hole portion 112a, the liquid contains the gas generally in from of bubbles 135 although the gas is dissolved to a certain degree (FIG. 5 is oversimplified and does not represent the actual size or number of bubbles). This can be referred to as a bubble-containing liquid phase 130. While the liquid flows toward the bottom of the container 111, the gas and the liquid tend to be separated due to the difference in specific gravity, thereby forming a gas-trapped phase 131. While the liquid is passing through the gas-trapped phase 131, the liquid is exposed to the gas and has more contact with the gas, thereby promoting dissolution of the gas into the liquid. Further, because the lower-end portion opening 113a is located in the vicinity of the bottom of the container 111, the liquid must be pushed up to the outflow-hole portion 112b through the tubular body 113 under pressure. This pressure effectively promotes dissolution of the gas into the liquid in the gas-trapped phase 131 and also in a gas-dissolved liquid portion 132.

The tubular body 113 has a sufficient length so that the liquid can contact the gas for a sufficient time period under sufficient pressure. For example, the tubular body 113 has a diameter of 5 mm to 100 mm, preferably 10 mm to 50 mm including 20 mm to 30 mm (e.g., approximately 25 mm) and has a length of 5 cm to 100 cm, preferably 10 cm to 40 cm including. 20 cm to 30 cm (e.g., approximately 25 cm). The tubular body may be constituted by a vinyl tube or other plastic tubes. The gap between the lower end of the tubular body and the bottom of the container 111 may be 2 mm to 20 mm, preferably 5 mm to 7 mm, so that appropriate pressure is exerted on the liquid when passing through the tubular body. The container may be made of PP/PE material and has a size sufficient for accommodating the tubular body, e.g., a diameter of approximately 120 mm and a length of approximately 350 mm when the tubular body has a diameter of approximately 25 mm and a length of approximately 240 mm.

When a warm bath apparatus like the one described above is used, first, water is stored in a pair of warm bathtubs for arms 21 and the warm bathtub for feet 22. Water stored in the warm bathtub for feet 22 is discharged to the liquid-treating apparatus 1 via the liquid-discharge pipe 43 by the sucking action of the pump 60. The water discharged to the liquid-treating apparatus 1 flows into the flow path 73 via the flow path 72. To the water having flowed into the flow path 73, carbon dioxide is supplied from the gas-supply mechanism 90. Additionally, when the water having flowed into the flow path 72 is discharged to outside without circulating it inside the warm bath apparatus, the water is discharged to the liquid-discharge pipe 82 by switching the directional control valve 52. Additionally, an amount supplied of carbon dioxide supplied from the gas-supply mechanism 90 can be adjusted by adjusting the control valve 91 and the check valve 92.

The gas pressure may be 0.05 MPa to 5 MPa, preferably 0.1 MPa to 1 MPa (e.g., 0.5 MPa), depending on the flow paths, the size of the bathtubs, etc. The gas pressure may be such that the gas-trapped phase 131 does not get close to the lower end of the tubular body. In an embodiment, the length of the gas-trapped phase 131 is less than that of the gas-dissolved liquid phase 132, e.g., approximately ⅓ of the length of the container 111. The liquid flow may be 1 L to 300 L/hour, preferably 10 L to 50 L/hour (e.g., 35 L/hour), depending on the size of the bathtubs, the flow paths, the gas pressure, etc. The gas can be introduced intermittently or continuously or as necessary. A user can set these parameters.

The water to which carbon dioxide has been supplied in the flow path 73 flows into the filtration mechanism 100. The water having flowed into the filtration mechanism 100 is purified by the action of the filter 103 in the filtration mechanism 100. The water having been purified in the filtration mechanism 100 flows into the flow path 74. The water having flowed into the flow path 74 flows into the mixing mechanism 110. Here, by the action of convection occurring inside the container 111, carbon dioxide supplied in the gas-supply mechanism 90 is dissolved moderately in the water having flowed into the mixing mechanism 110.

The water, in which carbon dioxide is dissolved moderately in this manner, flows into the flow path 75, and then flows into the heater 50. The water having flowed into the heater 50 is heated by the action of the heater 50. The water, a temperature of which has been raised, flows into the liquid-supply pipes 31, 32, and then flows out from the liquid-treating apparatus 1. Additionally, when the water a temperature of which has been raised by the heater 50 is discharged to the outside without being circulated in the warm bath apparatus, it can be discharged through the liquid-discharge pipe 81 to the outside by releasing the make-and-break valve 51.

As the heater 50, any suitable heater can be used including a U-shaped tube type heater. There is no restriction imposed on the type of heating means, which includes a gas heater and an electric heater. In an embodiment, by the heater, the temperature of the liquid may be controlled at 35-45° C., preferably 38-41° C.

The water having flowed into the liquid-supply pipes 31, 32 is supplied to a pair of warm bathtubs for arms 21. With the water having been supplied to the warm bathtubs for arms 21 via the liquid-supply pipes 31, 32, water stored previously in the warm bathtubs for arms overflows from the warm bathtubs for arms 21, and is discharged to the liquid-discharge pipes 41, 42. The water having been discharged into the liquid-discharge pipes 41, 42 flows into the liquid-supply pipe 33. The water having flowed into the liquid-supply pipe 33 flows into the warm bathtub for feet 22.

The water is purified as described above, and after carbon dioxide is dissolved by mixing it into the purified water, it becomes possible to circulate the water among the warm bathtubs for arms 21, the warm bathtub for feet 22 and the liquid-treating apparatus 1 while raising a temperature of the water.

Using the warm bath apparatus according to Embodiment 1 of the present invention, because water in which carbon dioxide has been dissolved is stored in the warm bathtubs, it becomes possible to promote blood circulation in the body by soaking parts of the body in the warm bathtubs.

An alternative embodiment of the present invention is described based on the drawings attached.

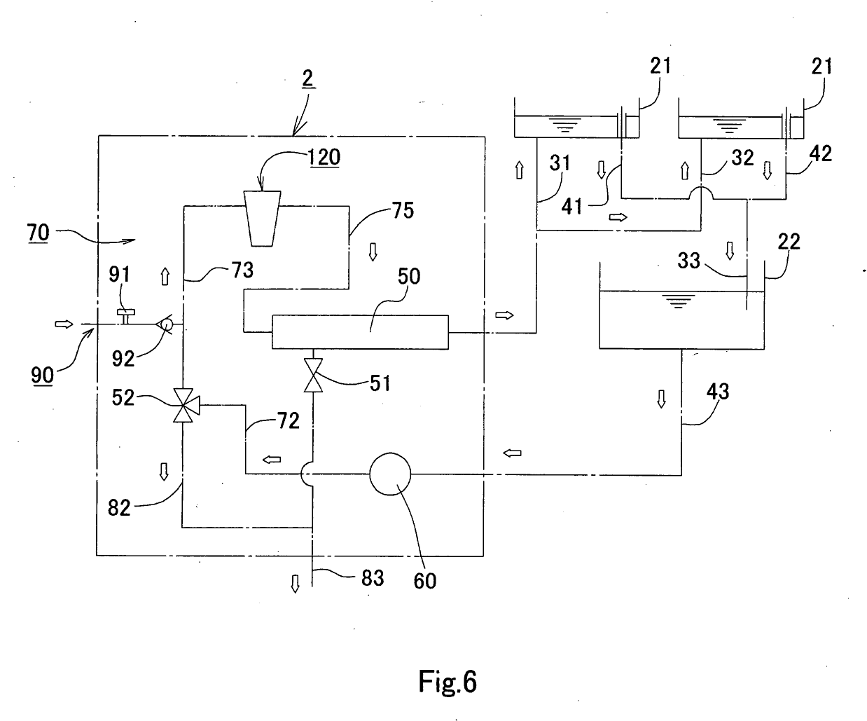

FIG. 6 is a schematic view showing liquid circulation in the warm bath apparatus according to Embodiment 2 of the present invention.

The warm bath apparatus according to Embodiment 2 of the present invention differs from the warm bath apparatus according to Embodiment 1 of the present invention in that it comprises a liquid-treating apparatus 2 in place of the liquid-treating apparatus 1 in the warm bath apparatus according to Embodiment 1 of the present invention. Additionally, the liquid-treating apparatus 2 according to Embodiment 2 of the present invention comprises a filtration/mixing mechanism 120 in place of the filtration mechanism 100, the flow path 74, and the mixing mechanism 110 provided in the liquid-treating apparatus 1 in the warm bath apparatus according to Embodiment 1 of the present invention.

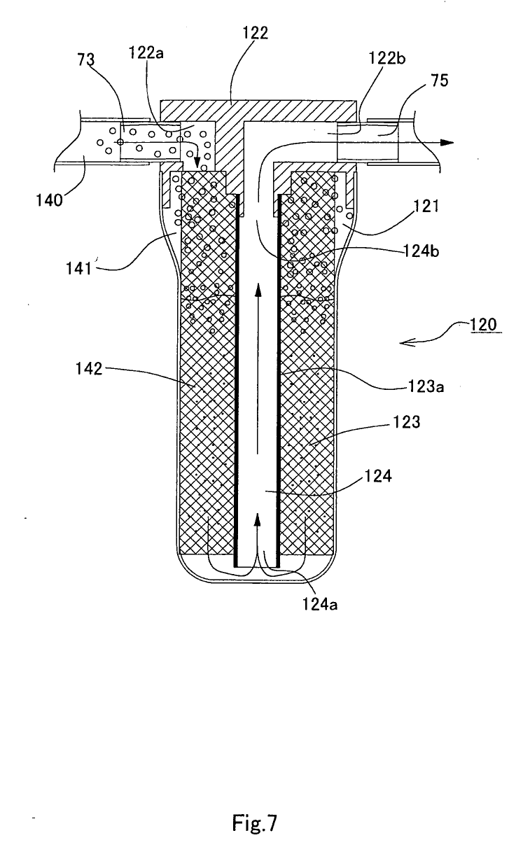

FIG. 7 is an explanatory view showing the filtration/mixing mechanism 120 comprising the warm bath apparatus according to Embodiment 2 of the present invention.

The filtration/mixing mechanism 120 comprises a tubular container 121 having an opening portion on its top, a lid member 122 for stopping the opening portion of the container 121, a filter disposed inside the container 121, and a tubular body 113 provided inside the container 121. In the lid member 122, an inflow-hole portion 122a being connected to the flow path 73 and passing through inside the container 121, and an outflow-hole portion 122b being connected to the flow path 74 and passing through inside the container 121 are formed. In the filter 123, a hole portion 123a passing through the tubular body 124 is formed. The tubular body 124 is disposed with an opening 124b of its upper-end portion being adjacent to the bottom portion of the container 121 and an opening 124b of its upper-end portion being connected to a flow path 75 via the outflow-hole portion 122b of the lid member 122. By this, after a liquid supplied form the flow path 73 is filtrated by the filter 123, by the action of convection generated by difference in specific gravity of a liquid and a gas, it becomes possible to discharge the gas to the flow path 75 after dissolving it in the liquid moderately.

In this embodiment, similarly to the embodiment shown in FIG. 5, a bubble-containing liquid phase 140, a gas-trapped phase 141, and a gas-dissolved liquid portion 142 are formed, thereby promoting dissolution of the gas into the liquid.

Using the warm bath apparatus according to Embodiment 2 of the present invention, because filtration of the water and dissolution of carbon dioxide in water can be achieved in the single filtration/mixing mechanism 120, it becomes possible to dissolve carbon dioxide in water moderately while maintaining the liquid cleanly for a long period of time although its configuration is simpler than the warm bath apparatus according to Embodiment 0.1.

Additionally, in the embodiment described above, the warm bath apparatus comprises warm bathtubs for arms 21 and a warm bathtub for feet 22. In place of the warm bathtubs for arms 21 and the a warm bathtub for feet 22, a regular warm bathtub, or warm bathtubs for soaking local body parts such as arms and feet may be provided.

Additionally, in the embodiment described above, a chair 10 having a massage feature with multiple protrusions, which can be slid up and down or horizontally using a motor, etc. as a drive source, or a vibration member being provided on the inside of a seat portion 11 or a backrest portion 12, may be provided.

Additionally, in the embodiment described above, a pair of warm bathtubs for arms may be configured to be movable horizontally, up and down or back and forth in reference to the chair 10. In this case, for example, the warm bathtubs 21 may be movable horizontally by connecting it to the chair 10 via a sliding member which can be slid horizontally in reference to the chair 10 using a motor, etc. as a drive source. Additionally, the bathtubs for arms may be configured to be movable up and down similarly by connecting it to the chair 10 via a sliding member which can be slid up and down in reference to the chair 10 using a motor, etc. as a drive source. Furthermore, the warm bathtubs 21 may be configured to be movable back and forth by connecting it to a sliding member for horizontal or up-and-down movement via a lever movable back and forth in reference to the chair 10, or to the chair 10. Thus, by configuring the warm bathtubs 21 to be movable horizontally, up and down, and back and forth, it becomes possible to use the warm bath apparatus by fitting it to a body size.

Additionally, in the embodiment described above, a reclining feature which can change an angle of inclination of the backrest portion 12 to the seat portion 11 may be provided.

Additionally, in the embodiment described above, the bathtub for feet 22 may be connected to a liquid-supply pipe 33 via a waterjet valve. By this, waterjet is generated inside the bathtub for feet 22, thereby making it possible to promote blood circulation in the body.

Further, although the embodiment described above comprises a gas-supply mechanism 90, in addition to the gas-supply mechanism 90, a blood-circulation-promoting-agent supply mechanism for supplying, for example, organic germanium, etc. having effect on promoting blood circulation in the body may be provided. In this case as well, by letting the liquid to which a blood-circulation-promoting-agent is supplied by the blood-circulation-promoting-agent supply mechanism pass through the mixing mechanism 100 in Embodiment 1 or the filtration/mixing mechanism 120 in Embodiment 2, it becomes possible to dissolve the blood-circulation-promoting-agent in the liquid moderately. These supplemental powers can be mixed in the liquid in the bathtubs.

The present invention includes the above mentioned embodiments and other various embodiments including the following:

1) The mixing mechanism comprises a chamber on top of which a hole portion connected to a liquid-inflow pipe is formed, and a tubular body provided inside the chamber with an opening of its lower-end portion being disposed adjacent to the bottom portion of the chamber, and an opening of its upper-end portion being connected to a liquid-outflow pipe, thereby making it possible to dissolve a gas in a liquid despite having a simple configuration;

2) The circulation mechanism comprises a filtration portion for purifying a liquid supplied from the warm bathtubs, thereby making it possible to maintain the liquid cleanly for a long period of time.

3) A gas to be mixed in a liquid being circulated by the circulation mechanism is supplied from a gas-supply mechanism connected to the liquid-inflow pipe via a check valve, thereby making it possible to prevent reverse flow of the liquid.

4) A gas to be mixed in a liquid is carbon dioxide, thereby making it possible to promote blood circulation in the body further.

5) The liquid is water, thereby making it possible to lower costs for using the warm bath apparatus.

6) The warm bathtubs comprise a warm bathtub for feet and a pair of warm bathtubs for arms, thereby making it possible to promote blood circulation in the body locally.

7) The circulation mechanism circulates the liquid between the warm bathtub for feet and a pair of warm bathtubs for arms, thereby making it possible to treat a liquid supplied to the warm bathtub for feet and a liquid supplied to a pair of warm bathtubs for arms at the same time.

8) The warm bath apparatus comprises a chair having a seat portion and a backrest portion, the warm bathtub for feet is disposed on the lower side of the seat portion in the chair, and the warm bathtubs for arms are disposed on each side of the seat portion in the chair, different parts of the body can be soaked in the warm bathtubs stably, thereby making it possible to further promote blood circulation in the body.

The present application claims priority to Japanese Patent Application No. 2004-334359, filed Nov. 18, 2004, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A warm bath apparatus comprising:
at least one bathtub;
a liquid-heating device;
a circulation system for circulating a liquid between the at least one bathtub and the heating device; and
a mixing unit for dissolving a gas by mixing the gas in the liquid being circulated by the circulation mechanism, said mixing mechanism comprising: (i) a gas-supply mechanism, (ii) a chamber provided downstream of the gas-supply mechanism and having a top portion provided with an inflow opening for introducing the liquid and an outflow opening for discharging the liquid, and (iii) a tubular hollow body provided inside the chamber and having an lower end disposed adjacent to a bottom of the chamber and an upper end connected to the outflow opening, wherein the liquid is to pass through the inflow opening, the lower end of the tubular body, the upper end of the tubular body, and the outflow opening in sequence after the gas is mixed therein.

2. The warm bath apparatus according to claim 1, wherein the chamber comprises a lid member which constitutes the top portion and a container connected to the lid member.

3. The warm bath apparatus according to claim 1, wherein the circulation system has a liquid-inflow pipe connected to the inflow opening of the top portion of the chamber, and a liquid-outflow pipe connected to the outflow opening of the top portion of the chamber.

4. The warm bath apparatus according to claim 3, wherein the gas-supply mechanism is connected to the liquid-inflow pipe for mixing the gas in the liquid passing through the liquid-inflow pipe.

5. The warm bath apparatus according to claim 4, wherein the gas-supply mechanism is connected to the liquid-inflow pipe via a check valve.

6. The warm bath apparatus according to claim 1, wherein the liquid-heating device is provided downstream of the mixing unit.

7. The warm bath apparatus according to claim 1, wherein the circulation system further comprises a filtration unit for purifying the liquid provided upstream of the mixing unit.

8. The warm bath apparatus according to claim 1, wherein the mixing unit further comprises a filtration portion provided inside the chamber between the inflow opening and the lower end of the tubular body.

9. The warm bath apparatus according to claim 1, wherein the circulation system further comprises a discharge pipe for discharging the liquid out of the circulation system upstream of the gas-supply mechanism.

10. The warm bath apparatus according to claim 1, wherein the gas-supply mechanism supplies carbon dioxide.

11. The warm bath apparatus according to claim 1, wherein the liquid is water.

12. The warm bath apparatus according to claim 1, wherein the at least one warm bathtub comprises a warm bathtub for feet and a pair of warm bathtubs for arms.

13. The warm bath apparatus according to claim 12, wherein the circulation system circulates the liquid between the warm bathtub for feet and the pair of warm bathtubs for arms.

14. The warm bath apparatus according to claim 12, further comprising a chair having a seat portion and a backrest portion wherein the warm bathtub for feet is disposed on a lower side of the seat portion in the chair, and the warm bathtubs for arms are disposed on each side of the seat portion in the chair.

15. The warm bath apparatus according to claim 1, wherein the liquid-heating device, the circulation system, and the mixing unit constitute a liquid-treating apparatus as a single module.

16. A method of using the warm bath apparatus of claim 1, comprising:
filling the at least one bathtub with the liquid;
circulating the liquid using the circulation system;
heating the liquid using the liquid-heating device;
supplying the gas using the gas-supply mechanism;
mixing the gas in the liquid using the mixing unit; and
controlling the liquid circulation and the gas supply wherein a gas-trapped portion is formed at an upper portion of the chamber which is a gas phase including the liquid, below which a gas-dissolved liquid portion is formed which is a liquid phase wherein the gas is dissolved.

17. The method according to claim 16, wherein in the gas-supplying step, carbon dioxide is supplied as the gas.

18. The method according to claim 16, wherein in the circulation step, water is circulated as the liquid.
